(19) United States
(12) Patent Application Publication
(10) Pub. No.: US 2013/0138981 A1
(43) Pub. Date: May 30, 2013

(54) POWER DISTRIBUTION METHOD AND SERVER SYSTEM USING THE SAME

(71) Applicants: Huang-Ching Wang, Taipei City (TW); Wan-Ching Lu, Taipei City (TW)

(72) Inventors: Huang-Ching Wang, Taipei City (TW); Wan-Ching Lu, Taipei City (TW)

(73) Assignee: INVENTEC CORPORATION, Taipei City (TW)

(21) Appl. No.: 13/436,480

(22) Filed: Mar. 30, 2012

(30) Foreign Application Priority Data
Nov. 30, 2011 (TW) 100143987

(51) Int. Cl. G06F 1/26

(52) U.S. Cl. 713/300

(57) ABSTRACT

A power distribution method suitable for a server system is provided. In the method, an average power is respectively supplied to activated motherboards, an expected power of each activated motherboard is read, and the expected power and the average power are compared, where if the expected power is greater than the average power, a first state is defined, and if the expected power is less than the average power, a second state is defined. Then, the expected powers of the motherboards defined as the second state and the average power are calculated to obtain a first remaining power. Then the first remaining power is averagely distributed to the motherboards defined as the first state. This method is capable of dynamically distributing power according to the needs of each of the motherboards and providing sufficient powers to the motherboards for operation.

### CROSS-REFERENCE TO RELATED APPLICATION

This application claims the priority benefit of Taiwan application serial no. 100143987, filed on Nov. 30, 2011. The entirety of the above-mentioned patent application is hereby incorporated by reference herein and made a part of this specification.

### BACKGROUND OF THE INVENTION

1. Field of the Invention

The invention relates to a power management technique. Particularly, the invention relates to a power distribution method applied to a server system.

2. Description of Related Art

Generally, power management of a server applies a static power capping, so as to averagely distribute a fixed power to each of motherboards. However, when the server operates, the power required by each of the motherboards is different. Expected powers of some motherboards are lower than the fixed power, and expected powers of some motherboards are higher than the fixed power, so that the conventional technique cannot effectively distribute power to the motherboards of different loads. In the motherboard with the expected power lower than the fixed power, the motherboard is distributed with an excessively high power capping value, and in the motherboard with the expected power higher than the fixed power, the motherboard is distributed with an excessively low power capping value. Namely, according to the current fixed power capping technique, the power is not distributed according to different needs of the motherboards, so that power usage efficiency is relatively poor.

How to resolve the power distribution problem of the conventional technique to implement dynamic adjustment is an important issue to be developed.

### SUMMARY OF THE INVENTION

Accordingly, the invention is directed to a power distribution method and a server system using the same, by which the problem mentioned in the related art are resolved.

The invention provides a power distribution method, which is adapted to a server system. The server system includes a plurality of motherboards, a fan module and a hard disk module. Each of the motherboards, the fan module and the hard disk module respectively has an expected power corresponding thereto, and the power distribution method includes following steps. An average power is respectively supplied to activated motherboards of the motherboards. Each of the expected power corresponding thereto of the activated motherboards of the motherboards is respectively read, and each of the expected power corresponding thereto is compared with the average power, where when the expected power corresponding thereto is greater than the average power, a first state is defined, and when the expected power corresponding thereto is less than the average power, a second state is defined. Each of the expected power corresponding thereto of the motherboards defined as the second state and the average power are calculated to obtain a first remaining power. The first remaining power is averagely distributed to the motherboards defined as the first state. The first remaining power is defined as a sum of powers supplied to the motherboards defined as the second state that respectively exceed each of the expected power corresponding thereto.

In an embodiment of the invention, the power distribution method further includes following steps. It is calculated whether a supply power of the motherboards defined as the first state is greater than the expected power, and when the supply power is greater than the expected power corresponding thereto, the first state is changed to a third state. Each of the expected power corresponding thereto of the motherboards defined as the third state and the supply power are calculated to obtain a second remaining power. The second remaining power is defined as a sum of powers supplied to the motherboards defined as the third state that respectively exceed each of the expected power corresponding thereto.

In an embodiment of the invention, the average power is obtained by dividing an applicable power by the number of the activated motherboards of the motherboards, and the applicable power is a total output power minus the expected power of the fan module and the expected power of the hard disk module.

In an embodiment of the invention, the power distribution method further includes following steps. The motherboards defined as the first state are set by a first logic level, and the motherboards defined as the second state are set by a second logic level.

In an embodiment of the invention, the power distribution method further includes storing information of a supplied power and a defined state of each of the motherboards.

According to another aspect, the invention provides a server system including a plurality of motherboards, a power supplying module and a center management bus. Each of the motherboards has an expected power corresponding thereto. The power supplying module outputs a total output power. The center management bus is electrically connected to the power supplying module and the motherboards, and receives the total output power to respectively supply an average power to activated motherboards of the motherboards. The center management bus includes a control module, and the control module respectively reads each of the expected power corresponding thereto of the activated motherboards of the motherboards, and compares each of the expected power corresponding thereto with the average power, where the control module defines a first state when the expected power is greater than the average power, defines a second state when the expected power is less than the average power, and calculates each of the expected power corresponding thereto of the motherboards defined as the second state with the average power to obtain a first remaining power. The center management bus averagely distributes the first remaining power to the motherboards defined as the first state, and the first remaining power is defined as a sum of powers supplied to the motherboards defined as the second state that respectively exceed each of the expected power corresponding thereto.

In an embodiment of the invention, in the server system, after the first remaining power is averagely distributed to the motherboards defined as the first state, the control module calculates whether a supply power of the motherboards defined as the first state is greater than the expected power corresponding thereto, and changes the first state to a third state when the supply power is greater than the expected power corresponding thereto, and calculates each of the expected power corresponding thereto of the motherboards defined as the third state with the supply power to obtain a second remaining power, where the second remaining power is defined as a sum of powers supplied to the motherboards defined as the third state that respectively exceed each of the expected power corresponding thereto.

In an embodiment of the invention, the server system further includes a fan module and a hard disk module. The fan module is electrically coupled to the center management bus, and the fan module has the expected power corresponding thereto. The hard disk module is electrically coupled to the center management bus, and the hard disk module has the expected power corresponding thereto. The average power is obtained by dividing an applicable power of the power supplying module by the number of the activated motherboards of the motherboards, where the applicable power is the total output power minus the expected power of the fan module and the expected power of the hard disk module.

In an embodiment of the invention, the center management bus further includes a memory. The memory is electrically coupled to the control module for storing a supplied power and the defined state of each of the motherboards.

In an embodiment of the invention, the control module includes a memory for storing a supplied power and the defined state of each of the motherboards.

According to another aspect, the invention provides a power distribution method, which is adapted to a server system. The server system comprises a plurality of devices. Each of the devices respectively has a expected power corresponding thereto. The power distribution method comprising: determining whether an average power supplied to each of the devices respectively being larger than the expected power corresponding thereto; calculating a sum of powers of at least one power excessive device of the plurality of devices that the average power being greater than the expected power corresponding thereto; and averagely distributing the sum of powers to at least one power insufficient device of the plurality of devices that the average power being less than the expected power corresponding thereto.

In an embodiment of the invention, the average power is obtained by dividing an applicable power by the plurality of devices.

In an embodiment of the invention, the applicable power is a total output power minus each of the expected power corresponding thereto of other devices of the server system.

According to the above descriptions, the center management bus applies a reasonable dynamic power distribution mechanism according to needs of the motherboards, which can effectively resolve the problem of power reliability of the conventional technique occurred due to applying of a fixed power distribution method. In this way, the motherboards can normally operate, and the power distribution is more efficient.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a server system according to an embodiment of the invention.

FIG. 2A is a flowchart illustrating a power distribution method according to an embodiment of the invention.

FIG. 2B is a flowchart illustrating a power distribution method according to another embodiment of the invention.

FIG. 3 is a flowchart illustrating a power distribution method according to another embodiment of the invention.

### DETAILED DESCRIPTION OF DISCLOSED EMBODIMENTS

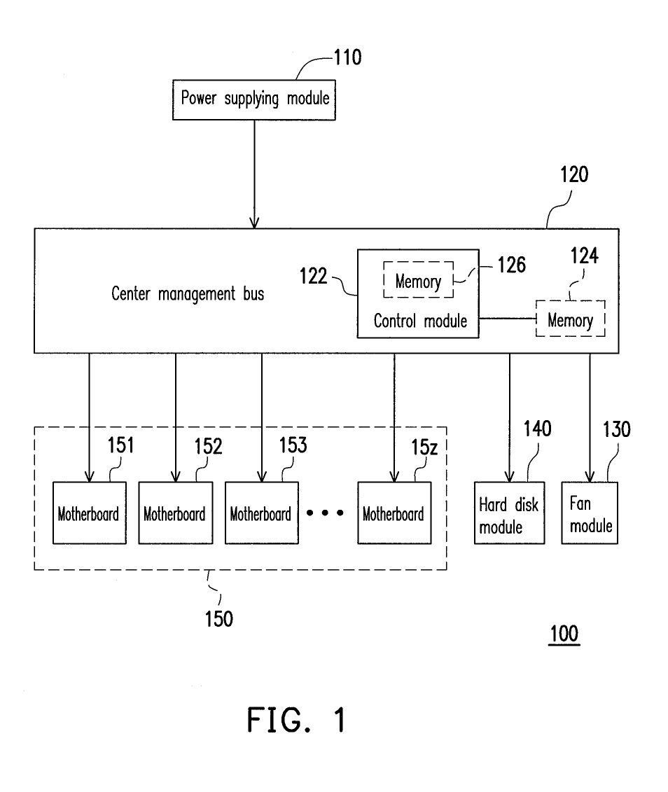

FIG. 1 is a schematic diagram of a server system according to an embodiment of the invention. Referring to FIG. 1, the server system 100 includes a power supplying module 110, a center management bus (CMB) 120, a plurality of motherboards 150 (where the device symbol 150 is a set of device symbols 151, 152, 153, . . . , 15z), a hard disc module 140 and a fan module 130. A user can set whether each of the motherboards 151, 152, 153, . . . , 15z is activated according to an actual requirement.

The power supplying module 220 receives an alternating current (AC) power, and outputs a direct current (DC) power after an AC/DC conversion, and the DC power is a total output power of the server system 100. The CMB 120 includes a control module 122, and the CMB 120 is electrically coupled to the power supplying module 110, the motherboards 151-15z, the hard disk 140 and the fan module 130. The power output from the power supplying module 110 can be distributed through the control module 122. The power distribution method is described later. A type of the control module 122 is not limited by the invention, and in another embodiment that is not illustrated, the control module 122 is an integrated circuit or a combined circuit having a logic operation processing capability, which is not limited by the invention.

Moreover, the CMB 120 may further include a memory 124, which is electrically coupled to the control module 122. The memory 124 is used to store information of a supplied power and a defined state of each of the motherboards 150.

In another embodiment, the control module 122 may include a memory 126.

The memory 126 is used to store information of the supplied power and the defined state of each of the motherboards 150.

Therefore, the control module 122 can read information of the currently supplied power and the currently defined state through the memory 124 or 126. A position of the memory is not limited by the invention.

In an exemplary embodiment of the invention, the CMB 120 can be a fan control board of the server system 100, though the invention is not limited thereto.

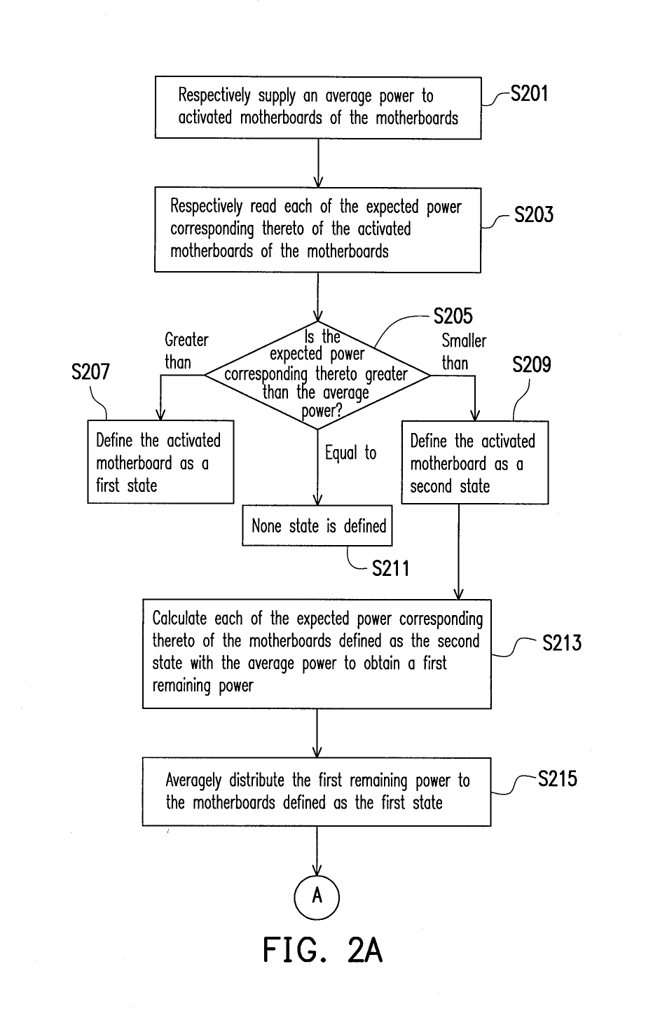

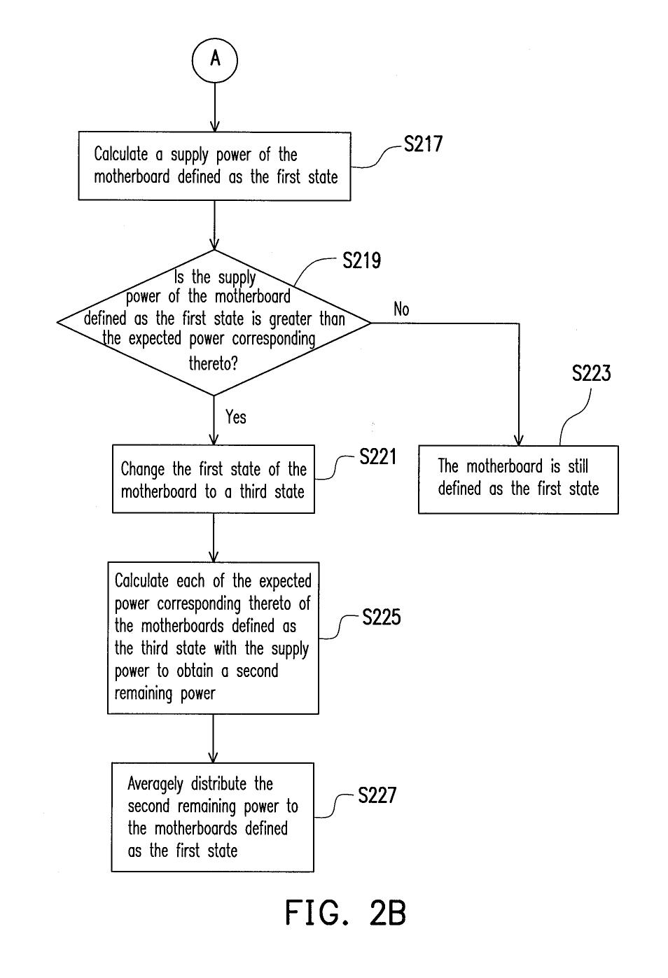

It should be noticed that in the present embodiment, the CMB 120 applies a dynamic power distribution mechanism according to needs of the motherboards. A detailed operation flow the components in the server system 100 is described below with reference of FIG. 2A. Referring to FIG. 1, FIG. 2A and FIG. 2B.

Generally, when the user operates the server system 100, the user can set whether or not to activate each of the motherboards 151, 152, 153, . . . , 15z according to the actual system requirement. Each of the motherboards 150 has an expected power corresponding thereto. The control module 122 of the CMB 120 reads the number of the activated motherboards of the motherboards 150. In step S201, the CMB 120 receives the total output power from the power supplying module 220 for supplying to the motherboard 151-15z, the hard disk 140 and the fan module 130. The CMB 120 respectively supplies an average power to N activated motherboards of the motherboards 150. Since the power supplying module 220 provides power for all devices in the server system 100, when the average power to be respectively output to the N motherboards is calculated, each of the expected power corresponding thereto of non-motherboard elements is first subtracted, for example, each of the expected power corresponding thereto of non-motherboard elements such as the fan module 130 and the hard disk module 140, etc. are subtracted from the total output power to obtain an applicable power. The control module 126 divides the applicable power by the number (N) of the activated motherboards to obtain the average power. As known by those skilled in the art, a value of the average power is varied along with the number of the activated motherboard.

The average power can be represented as follows:

The average power=(the total output power−the expected power of the fan module 130−the expected power of the hard disk module 140)/N=applicable power/N.

Similarly, in an embodiment that is not illustrated, if the fan module 130 and the hard disk module 140 are not powered by the power supplying module 110, the average power=the total output power/N.

Then, in step S203, the control module 122 respectively reads each of the expected power corresponding thereto of the activated motherboards of the motherboards 150. The expected power corresponding thereto is a power required by the motherboard for a normal operation or maintaining an optimal operation state under a current mode (for example, a normal operation mode, a sleep mode or a deep sleep mode, etc), and a magnitude of the expected power is, for example, determined by a manufacturer of the server system 100 or the motherboards 151-15z, though the invention is not limited thereto.

Then, in step S205, the control module 122 determines whether each of the expected power corresponding thereto the activated motherboards is greater than the average power, i.e. determines whether the power supplied to each of the motherboards is enough to maintain a normal operation of the motherboard. If the expected power corresponding thereto is greater than the average power, in step S207, the control module 122 defines at least one of the activated motherboards to be a first state. If the expected power corresponding thereto is smaller than the average power, in step S209, the control module 122 defines at least one of the activated motherboards to be a second state. If the expected power corresponding thereto is just equal to the average power, in step S211, the control module 122 does not define any state for the activated motherboard.

Then, in step S213, the control module 122 calculates each of the expected power corresponding thereto of the motherboards defined as the second state with the average power to obtain a first remaining power, where the first remaining power is defined as a sum of powers supplied to the motherboards defined as the second state that respectively exceed the expected power corresponding thereto.

Then, in step S215, the control module 122 averagely distributes the first remaining power to the motherboards defined as the first state.

In the present embodiment, once the steps S201 to S215 are executed, by distributing the first remaining power, the problem of power reliability of the conventional technique occurred due to applying of a fixed power distribution method is effectively resolved.

In another embodiment, after distribution of the first remaining power, if the power distributed to the motherboard does not reach the expected power corresponding thereto, the power distribution method may further include following steps. Referring to FIG. 1 and FIG. 2B, in which a step A represents a step following the step S215 of FIG. 2A. After the step S215, in order to increase operation flexibility of the power distribution method, following steps are executed.

In step S217, the control module 122 calculates a supply power of the motherboard defined as the first state, where the supply power is the average power of the step S201 plus the averagely distributed first remaining power in the step S215.

Then, in step S219, the control module 122 determines whether the supply power of the motherboard defined as the first state is greater than the expected power corresponding thereto. If the determination result is affirmative, it represents that the supply power is greater than the expected power corresponding thereto, and in step S221, the control module 122 changes the first state of the motherboard to a third state, and a step S225 is executed. If the determination result is negative, it represents that the supply power does not reach the expected power corresponding thereto, and in step S223, the motherboard is still defined to be the first state.

In the step S225, the control module 122 calculates each of the expected power corresponding thereto of the motherboards defined as the third state with the supply power to obtain a second remaining power, where the second remaining power is defined as a sum of powers supplied to the motherboards defined as the third state that respectively exceed the expected power corresponding thereto.

Then, in step S227, the control module 122 averagely distributes the second remaining power to the motherboards defined as the first state. The distribution method can be repeated until each of the supply powers of the motherboards is equal to or greater than the expected power corresponding thereto.

The steps S217 to S227 are steps related to distribution implementation of the second remaining power in the power distribution method.

In the present embodiment, once the steps S217 to S227 are executed, by distributing the second remaining power, the power can be reasonably and preferably distributed to the motherboards, and besides the elements and the motherboards can normally operate, an operation performance of the whole system is improved. On the other hand, according to the power distribution method of the present embodiment, energy is saved, and equipment cost is effectively reduced.

Another example is provided below to describe distributions of the first and the second remaining powers in detail, referring to FIG. 1, for simplicity's sake, it is assumed that there are only four motherboards in FIG. 1 (i.e. N=4), the motherboards 151, 152, 153 and 15z are all activated, and the distributed average power is 250 W, i.e. the power output to the motherboards 151, 152, 153 and 15z by the power supplying module 110 at an initial stage is 250 W.

Now, the control module 122 checks each of the expected power corresponding thereto of the activated motherboards, so that the control module 122 reads the expected powers of the motherboards 151, 152, 153 and 15z from the memory 124 or 126. It is assumed that the expected powers of the motherboards are respectively 200 W of the motherboard 151, 200 W of the motherboard 152, 300 W of the motherboard 153 and 250 W of the motherboard 15z. During the control module 122 performs inspection, if the expected power corresponding thereto of the motherboard is greater than the average power, the motherboard is defined as the first state. If the expected power corresponding thereto of the motherboard is smaller than the average power, the motherboard is defined as the second state. If the expected power corresponding thereto is just equal to the average power, none state is defined. Therefore, the expected power 300 W of the motherboard 153 is greater than the average power 250 W, and the motherboard 153 is defined as the first state. The expected power 200 W of the motherboards 151 and 152 is smaller than the average power 250 W, and the motherboards 151 and 152 are defined as the second state. The expected power 250 W of the motherboard 15z is just equal to the average power 250 W, and the motherboard 15z is not defined as any state.

On the other hand, to facilitate distributing the power, the control module 122 sets the motherboards defined as the first state by a first logic level (for example, a logic high level), and sets the motherboards defined as the second state by a second logic level (for example, a logic low level). Setting of the logic levels can be reversed, which is not limited by the invention.

Then, the control module 122 dynamically distributes the first remaining power, and averagely distributes the first remaining power to the motherboard 153 defined as the first state. The first remaining power is defined as a sum of powers supplied to the motherboards 151 and 152 defined as the second state that respectively exceed the expected power corresponding thereto. The first remaining power can be represented as follows:

first remaining power=(250 W−200 W)_{motherboard 151}+(250 W−200 W)_{motherboard 152}=100 W.

Since the number of the motherboard of the first state is only one, the power of 100 W is additionally distributed to the motherboard 153, i.e. a total power of 350 W is distributed to the motherboard 153. In this state, since the powers supplied to the motherboards 151 and 152 are individually reduced by 50 W, the power of 200 W is distributed thereto, and the motherboard 15z is maintained to the power of 250 W. Namely, the powers respectively supplied to the motherboards 151, 152, 153 and 15z are respectively 200 W, 200 W, 350 W and 250 W. It should be noticed that the invention is not limited thereto, for example, when the number of the motherboards of the first state is y, the first remaining power is divided by y for distribution.

In this way, under a basic situation of using the same power supplying module 110, compared to the static fixed power distribution method, power reliability is ensured by redistributing the remaining power. Moreover, the power distribution is more efficient and power saving.

Moreover, a further power distribution can be performed to even the power distributed to the motherboards, which is described as follows. The control module 122 checks whether the supply power distributed to the motherboard 153 of the first state exceeds the expected power corresponding thereto. If the supply power distributed to the motherboard 153 exceeds the expected power corresponding thereto, the motherboard 153 is defined as the third state. Since the power distributed to the motherboard 153 is 350 W, the control module 122 defines the motherboard 153 as the third state by determining that the distributed value exceeds the expected power 300 W of the motherboard 153. Therefore, the control module 122 calculates to obtain the second remaining power, and averagely distributes the second remaining power to the motherboards defined as the first state. Since none motherboard of the first state exists in the provided embodiment, the power distribution is ended.

The second remaining power can be represented as follows:

second remaining power=(350 W−300 W)_{motherboard 153}=50 W.

As known by those skilled in the art, the control module 122 can again distribute the second remaining power to the motherboards 151 and 152 or no longer performs power distribution, which is determined according to an actual requirement.

According to the above descriptions, the dynamic power distribution of the server system 100 of the present embodiment can be listed in a following table one:

TABLE ONE

| | Motherboard/expected power corresponding thereto | | | |
|---|---|---|---|---|
| | Motherboard | Motherboard | Motherboard | Motherboard |
| | 151/200 W | 152/200 W | 153/300 W | 15z/250 W |
| Average power distributed | 250 W | 250 W | 250 W | 250 W |
| to each motherboard | | | | |
| State inspection | Second state | Second state | First state | State |
| | | | | undefined |
| Calculation of first | 250 − 200, to | 250 − 200, to | | |
| remaining power, total 100 W | obtain 50 W | obtain 50 W | | |
| Redistribution of first | 200 W | 200 W | 350 W | 250 W |
| remaining power, and re- | | | third state | |
| inspection of motherboard | | | | |
| of third state | | | | |
| Calculation of second | | | 350 − 300(W), | |
| remaining power, total 50 W | | | to obtain 50 W | |

Moreover, a supplied power (power capping value) and a defined state of each of the motherboards can be recorded in the memory 124 or the memory 126. If a load state of the motherboard is changed, the control module 122 can recalculate to perform the power distribution, i.e. a real-time power distribution is performed according to the needs of each of the motherboards. Similarly, if a power-on state or the load state of the motherboard is not changed, the control module 122 controls the power supplying module 110 to continually supply power to each of the elements according to the power capping values.

Moreover, when the server system 100 is rebooted, the control module 122 can quickly perform the power distribution according to the power capping values recorded in the memory 124 or 126. Therefore, according to the solution of the present embodiment, while an energy usage upper limit is confined or set, the operating performance of the system is also considered.

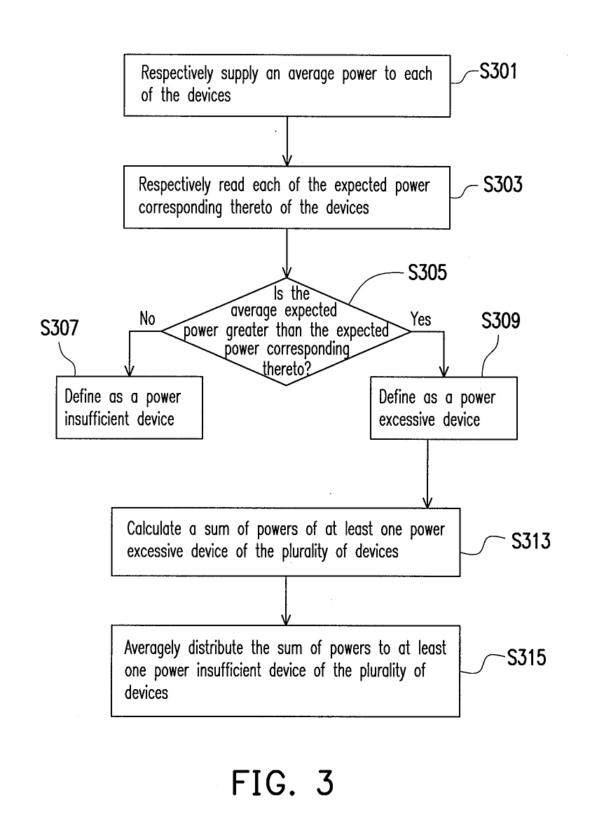

A power distribution method is deduced according to instructions of the aforementioned embodiment. In detail, FIG. 3 is a flowchart illustrating a power distribution method according to another embodiment of the invention. Referring to FIG. 3, the power distribution method of the embodiment, which is adapted to a server system. The server system comprises a plurality of devices. Each of the devices respectively has an expected power corresponding thereto. The power distribution method includes following steps.

In step S301, the server system respectively supplies an average power to each of the devices. Then, in step S303, the server system respectively read expected powers of the devices. And then in step S305, the server system determines whether the average power greater than the expected power. If the average power is less than the expected power, in step S307, the server system defines as a power insufficient device when the average power being less than the expected power. If the average power is greater than the expected power, in step S309, the server system defines as a power excessive device when the average power being greater than the expected power.

Then, in step S313, the server system calculates a sum of powers of at least one power excessive device of the plurality of devices. Then, in step S315, the server system averagely distributes the sum of powers to at least one power insufficient device of the plurality of devices.

In the present embodiment, the average power is obtained by dividing an applicable power by the plurality of devices, and the applicable power is a total output power minus each of the expected power corresponding thereto of other devices of the server system.

In summary, the center management bus applies a reasonable dynamic power distribution mechanism according to the needs of the motherboards, which can effectively resolve the problem of power reliability of the conventional technique occurred due to applying of the fixed power distribution method. In this way, various elements and the motherboards can normally operate to achieve a high system performance. On the other hand, according to the power distribution method of the invention, energy is saved, and equipment cost is effectively reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power distribution method, adapted to a server system, wherein the server system comprises a plurality of motherboards, a fan module and a hard disk module, each of the motherboards, the fan module and the hard disk module respectively has an expected power corresponding thereto, and the power distribution method comprising:
respectively supplying an average power to activated motherboards of the motherboards;
respectively reading each of the expected power corresponding thereto of the activated motherboards of the motherboards, and comparing each of the expected power corresponding thereto with the average power, wherein when each of the expected power corresponding thereto is greater than the average power, a first state is defined, and when each of the expected power corresponding thereto is less than the average power, a second state is defined;
calculating each of the expected power corresponding thereto of the motherboards defined as the second state with the average power to obtain a first remaining power; and
averagely distributing the first remaining power to the motherboards defined as the first state,
wherein the first remaining power is defined as a sum of powers supplied to the motherboards defined as the second state that respectively exceed each of the expected power corresponding thereto.

2. The power distribution method as claimed in claim 1, further comprising:
calculating whether a supply power of the motherboards defined as the first state is greater than the expected power corresponding thereto, and changing the first state to a third state when the supply power is greater than the expected power corresponding thereto; and
calculating each of the expected power corresponding thereto of the motherboards defined as the third state with the supply power to obtain a second remaining power,
wherein the second remaining power is defined as a sum of powers supplied to the motherboards defined as the third state that respectively exceed each of the expected power corresponding thereto.

3. The power distribution method as claimed in claim 1, wherein the average power is obtained by dividing an applicable power by a number of the activated motherboards of the motherboards, and the applicable power is a total output power minus the expected power of the fan module and the expected power of the hard disk module.

4. The power distribution method as claimed in claim 1, further comprising:
respectively setting the motherboards defined as the first state by a first logic level; and
respectively setting the motherboards defined as the second state are represented by a second logic level.

5. The power distribution method as claimed in claim 1, further comprising storing information of a supplied power and a defined state of each of the motherboards.

6. A server system, comprising:
a plurality of motherboards, each having an expected power corresponding thereto;
a power supplying module, outputting a total output power; and
a center management bus, electrically connected to the power supplying module and the motherboards, and receiving the total output power to respectively supply an average power to activated motherboards of the motherboards, wherein the center management bus comprises a control module, and the control module respectively reads each of the expected power corresponding thereto of the activated motherboards of the motherboards, and compares each of the expected power corresponding thereto with the average power, wherein the control module defines a first state when the expected power corresponding thereto is greater than the average power, defines a second state, and when the expected power corresponding thereto is less than the average power, and calculates each of the expected power corresponding thereto of the motherboards defined as the second state with the average power to obtain a first remaining power,
wherein the center management bus averagely distributes the first remaining power to the motherboards defined as the first state, and
the first remaining power is defined as a sum of powers supplied to the motherboards defined as the second state that respectively exceed each of the expected power corresponding thereto.

7. The server system as claimed in claim 6, wherein after the first remaining power is averagely distributed to the motherboards defined as the first state, the control module calculates whether a supply power of the motherboards defined as the first state is greater than the expected power corresponding thereto, changes the first state to a third state when the supply power is greater than the expected power corresponding thereto, and calculates each of the expected power corresponding thereto of the motherboards defined as the third state with the supply power to obtain a second remaining power,
where the second remaining power is defined as a sum of powers supplied to the motherboards defined as the third state that respectively exceed each of the expected power corresponding thereto.

8. The server system as claimed in claim 6, further comprising:
a fan module, electrically coupled to the center management bus, and having the expected power corresponding thereto; and
a hard disk module, electrically coupled to the center management bus, and having the expected power corresponding thereto,
wherein the average power is obtained by dividing an applicable power of the power supplying module by the number of the activated motherboards of the motherboards, and the applicable power is the total output power minus the expected power of the fan module and the expected power of the hard disk module.

9. The server system as claimed in claim 6, wherein the center management bus further comprises:
a memory, electrically coupled to the control module, and storing information of a supplied power and a defined state of each of the motherboards.

10. The server system as claimed in claim 6, wherein the control module comprises a memory for storing information of a supplied power and a defined state of each of the motherboards.

11. A power distribution method, adapted to a server system, wherein the server system comprises a plurality of devices, each of the devices respectively has a expected power corresponding thereto, and the power distribution method comprising:
determining whether an average power supplied to each of the devices respectively being larger than the expected power corresponding thereto;
calculating a sum of powers of at least one power excessive device of the plurality of devices that the average power being greater than the expected power corresponding thereto; and
averagely distributing the sum of powers to at least one power insufficient device of the plurality of devices that the average power being less than the expected power corresponding thereto.

12. The power distribution method as claimed in claim 11, wherein the average power is obtained by dividing an applicable power by the plurality of devices.

13. The power distribution method as claimed in claim 12, wherein the applicable power is a total output power minus each of the expected power corresponding thereto of other devices of the server system.
